(19) United States
(12) Patent Application Publication
(10) Pub. No.: US 2008/0212921 A1
(43) Pub. Date: Sep. 4, 2008

(54) OPTICAL INTERCONNECT DEVICES AND STRUCTURES BASED ON METAMATERIALS

(75) Inventors: Thomas K. Gaylord, Atlanta, GA (US); Justin L. Stay, Suwanee, GA (US); James D. Meindl, Marietta, GA (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 12/041,491

(22) Filed: Mar. 3, 2008

Related U.S. Application Data
(60) Provisional application No. 60/892,558, filed on Mar. 2, 2007.

(51) Int. Cl. G02B 6/12; G02B 6/10

(52) U.S. Cl. 385/14; 385/131

(57) ABSTRACT

Improved optical interconnect devices, structures, and methods of making and using the devices and structures are provided herein. The optical interconnect devices, which can be used to connect components or route signals in an integrated-circuit or circuits, generally include an optical element having a metamaterial with a negative index of refraction. The optical element is configured to receive an optical signal from a first component and transmit the optical signal to a second component. Each interconnect device or structure can be fabricated to have a small size and complex functionalities integrated therein. Other embodiments are also claimed and described.

### CROSS-REFERENCE TO RELATED APPLICATIONS

The present application claims the benefit of U.S. Provisional Patent Application No. 60/892,558, filed 2 Mar. 2007, and entitled “Optical Interconnect Devices Based on Metamaterials”, which is hereby incorporated by reference in its entirety as if fully set forth below.

### TECHNICAL FIELD

The various embodiments of the present invention relate generally to integrated-circuit interconnect devices, and more particularly, to optical interconnect devices and structures that can be integrated-circuit transmission systems or connection components, and to methods for making and using such devices and structures.

### BACKGROUND

The demands for ever-increasing bandwidths in digital data communication equipment at reduced power consumption levels are constantly growing. These demands not only require more efficient integrated-circuit components, but also higher performance interconnect structures and devices and chip-to-substrate connections. Indeed, as one example, the International Technology Roadmap for Semiconductors (ITRS) projects that high performance chips in the very near future will have operating frequencies, both on-chip and off-chip (e.g., chip to substrate), rising above 50 GHz.

Conventional metal-wire based interconnects have played a central role in the microelectronics revolution. Microelectronic chips have grown steadily both in terms of size and density. As very large-scale integration (VLSI) is replaced by gigascale integration (GSI), conventional wire-based interconnections have become severely challenged owing to increased demands on power, space, speed, design, and the like. Clearly, wire-based interconnect devices will not be capable of enabling even higher operating frequencies, such as those projected in the ITRS.

One approach to this problem includes utilizing optical interconnects as an alternative to wire-based interconnections. Optics has widespread use in long-distance communications; yet it has not been widely used in chip-to-chip or on-chip interconnections. As optical interconnections move from computer network applications to chip level interconnections, new demands for high connection density and alignment reliability have become especially important for the effective utilization of these components. Unfortunately, there are still many materials, fabrication, and packaging challenges in integrating optic and electronic technologies.

Accordingly, there remains a need for improved optical interconnect devices and structures. It would be particularly beneficial if these improved devices and structures could overcome the unmet challenge in optical interconnects of having very small sizes and complex functionalities integrated into a single device or structure. It is to the provision of such interconnects that the various embodiments of the present invention are directed.

### BRIEF SUMMARY

Various embodiments of the present invention are directed to optical interconnect devices and structures. Some embodiments are also directed to methods of fabricating the optical interconnect devices and structures. Still other embodiments are directed to methods of using the optical interconnect devices and structures. When discussing the various embodiments of the present invention herein, reference is sometimes made to interconnections, interconnects, interconnect structures, interconnect devices, and transmission systems. These terms are intended to be used interchangeably.

As discussed in more detail below, certain embodiments of the present invention can be implemented as on-chip interconnects and other embodiments can be implemented as off-chip interconnects. As used herein, on-chip interconnects can be used to connect certain points or areas on a single chip, and off-chip interconnects can be used to connect multiple components such as an integrated chip with an associated substrate or two discrete integrated chips. Also, embodiments of the present invention can serve as high performance interfaces between components.

Broadly described, an interconnect device according an embodiment of the present invention can include an optical element having a metamaterial. The metamaterial can have a negative index of refraction. The optical element can be configured to receive an optical signal from a first component and transmit the optical signal to a second component. The optical element can have other characteristics in accordance with embodiments of the present invention. For example, the optical element can have a planar or substantially planar shape. The optical element can also have a negative index of refraction at a wavelength of light of about 1.3 micrometers to about 2.0 micrometers. In some embodiments, the index of refraction of the optical element is −1 or about −1.

The metamaterial can have a grid-shaped structure formed from a metal-dielectric-metal sandwich. In other instances, the metamaterial can be formed from a plurality of staggered nanorods, where the nanorods have parallel longitudinal axes and each nanorod is formed from a metal-dielectric-metal sandwich. In still other instances, the metamaterial can be an array of a plurality of parallel metal wires arranged in a square lattice and a plurality of split-ring resonators.

An optical interconnect system can include a microelectronic chip and an optical element. The optical element can include a metamaterial having a negative index of refraction. In addition, the optical element can be configured to receive an optical signal from a component of the microelectronic chip. The optical element can be configured to transmit the optical signal to the component of the microelectronic chip. In some embodiments, the optical element can be configured to receive an optical signal from a component of the microelectronic chip and transmit the optical signal to the component of the microelectronic chip.

The optical interconnect system can also include an optical fiber or fibers. The optical fiber or fibers, if included, can be in optical communication with the component of the microelectronic chip via the optical element. The optical interconnect system can also include an additional or second component. In these cases, the additional component of the microelectronics chip can be in optical communication with the first or original component of the microelectronic chip via the optical element. In still other embodiments, the optical interconnect system can also include an additional microelectronic chip and an additional component on the additional microelectronics chip. In these situations, the component of the microelectronic chip can be in optical communication with the additional component of the additional microelectronic chip via the optical element. The optical communication referred to for the above embodiments can be either unidirectional or bidirectional.

In other optical interconnect system embodiments, the system can include an optical source, and optical detector, an optical element, and a microelectronic chip. The optical source can be configured to provide an optical signal, while the optical detector can be configured to detect the optical signal. The optical element can be interposed between the optical source and the optical detector. The optical element, which can include a metamaterial having a negative index of refraction, can be configured to receive the optical signal from the optical source and/or transmit the optical signal to the optical detector. In certain cases, one or more of the optical source, optical detector, or optical element are in physical communication (disposed on or embedded within) with a microelectronic chip. In one such case, the optical source, optical detector, and optical element are in physical communication with the same microelectronic chip. In another such case, the optical source, optical detector, and optical element are each in physical communication with various microelectronic chips.

It is also possible for the optical interconnect system to further include an optical fiber or fibers. In some cases the optical fiber or fibers can be interposed between the optical source and the optical element. In other cases, it can be interposed between the optical detector and the optical element. Other items that the optical interconnect system can have, include an optical waveguide, a refractive element, a diffractive element, or a reflective element. It is also possible for the optical interconnect system to have more than one of these items. These items can be interposed between the optical source and the optical element and/or between the optical detector and the optical element.

Other aspects and features of embodiments of the present invention will become apparent to those of ordinary skill in the art, upon reviewing the following description of specific, exemplary embodiments of the present invention in conjunction with the accompanying figures.

### BRIEF DESCRIPTION OF DRAWINGS

FIGS. 1 (a)-(c) illustrates various metamaterial structures in accordance with some embodiments of the present invention.

FIG. 2 is a schematic illustration of an optical interconnect configured as a fiber-to-chip coupler according to some embodiments of the present invention.

FIG. 3 is a schematic illustration of an optical interconnect configured as a waveguide in accordance with some embodiments of the present invention.

FIG. 4 is a schematic illustration of an optical interconnect configured to operate over a series of locations (on-chip and/or off-chip) according to some embodiments of the present invention.

FIG. 5 is a schematic illustration of a three-dimensional inter-chip optical interconnect in accordance with some embodiments of the present invention.

FIG. 6 is a schematic illustration of the optical paths of two different inter-chip optical interconnects according to some embodiments of the present invention.

FIG. 7 is a schematic illustration of a fiber-to-three-dimensional chip optical interconnect in accordance with some embodiments of the present invention.

FIG. 8 is a schematic illustration of a vertical intra-chip optical interconnect according to some embodiments of the present invention.

FIG. 9 is a schematic illustration of a horizontal intra-chip optical interconnect in accordance with some embodiments of the present invention.

### DETAILED DESCRIPTION

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented. In addition, the terms “first,” “second,” and the like; “primary,” “secondary,” and the like; “top,” “bottom,” “above,” “below,” and the like do not denote any order, quantity, or importance, but rather are used to distinguish one element from another. Further, the terms “a”, “an”, and “the” do not denote a limitation of quantity, but rather denote the presence of “at least one” of the referenced item.

The various embodiments of the present invention provide improved optical interconnect devices and structures. As will be described in more detail below, the optical interconnects can be on-chip or off-chip interconnect structures. More specifically, on-chip interconnects can be used to connect certain points or areas on a single chip. Off-chip interconnects can be used to connect multiple components such as an integrated chip and an associated substrate or two discrete integrated chips. Optical interconnects fabricated in accordance with embodiments of the present invention can exhibit lossless characteristics and can also be compact to enable small integrated package sizes. In addition, the optical interconnects disclosed herein can serve as an alternative to, or act in conjunction with, existing wire-based interconnects.

The optical interconnect structures according to the present invention are generally based on the use of a (i.e., at least one) metamaterial-based optical element, such as a lens, that has a negative index of refraction (n). A metamaterial, or meta material, is a material that exhibits properties derived from its structure rather than directly from its composition. Metamaterials are sub-wavelength structured materials that fall in the category of materials described by “effective media” theory. That is, the details of the structure are small compared to a wavelength. The incident light only senses the average or “effective” material characteristics. Under the right circumstances, metamaterials can have negative refractive indices.

By way of explanation, when a beam of light enters a material, it usually slows down and changes direction. The degree to which this happens is determined by the refractive index of the material. The index of refraction, in general, is defined by n=±(∈ᵣμᵣ)^{1/2}, where the relative electric permittivity is indicated by or and the relative magnetic permeability is indicated by μᵣ. For a metamaterial to have a negative index of refraction, it must simultaneously exhibit both negative dielectric behavior and negative magnetic behavior. In such a case when both ∈ᵣ and μᵣ are less than zero, the refractive index is negative. That is, n=−(∈ᵣμᵣ)^{1/2}; it is not n=+(∈ᵣμᵣ)^{1/2}.

A practical implication of a metamaterial with a negative index of refraction is the different effect observed for light propagation through it. Refraction at an interface in optics follows Snell's law. When the interface includes a positively refracting material and a negatively refracting material, a reversal of Snell's law is observed (i.e., light rays will refract on the same side of the normal vector upon entering the negatively-refracting material).

For example, if an optical element comprising a negatively refracting metamaterial has a convex shape, it will diverge collimated incident light (rather than converging the incident light, which would be expected for a positively refracting material of any kind). Similarly, if an optical element comprising a negatively refracting metamaterial has a concave shape, it will converge collimated incident light (rather than diverging the incident light, which would be expected for a positively refracting material of any kind). Finally, if an optical element comprising a negatively refracting metamaterial has a flat or planar shape, then it will focus the rays of collimated incident light.

In fact, a planar metamaterial-based negatively refracting optical element has no optical axis and can reconstitute the near-field as well as the far-field of the source into an image or pattern with sub-wavelength resolution. That is, the resulting focused pattern can contain details much smaller than the wavelength of the source or incident light. This type of imaging is not possible with a positive-refractive-index material. A planar metamaterial-based negatively refracting optical element of this type is not subject to the diffraction limit that is associated with conventional optics. In order to achieve such focusing performance, however, the optical element should have ∈ᵣ=−1 and μᵣ=−1, which results in n=−1. An optical element of this type is termed a “super lens” or “perfect lens” because not only are the propagating rays focused by this optical element, but any evanescent non-propagating waves are transmitted faithfully. Thus, metamaterials can potentially offer lossless control of light propagation at a size scale much smaller than the wavelength of light.

The improved optical interconnect devices disclosed herein are based on the light controlling ability that comes with negative refractive index metamaterials. Optical interconnects in microelectronic chips generally focus light, guide light, and/or bend light. In practice, the intensity and phase profiles of the source light beams will deviate from ideal, uniform or Gaussian beams. To maximize effectiveness, the optical elements in optical interconnect devices and systems should be able to focus and manipulate such practical irregular beams. Owing to their properties, as described only briefly above, metamaterials-based negatively refracting optical elements are well suited to perform the above operations on ideal or non-ideal beams.

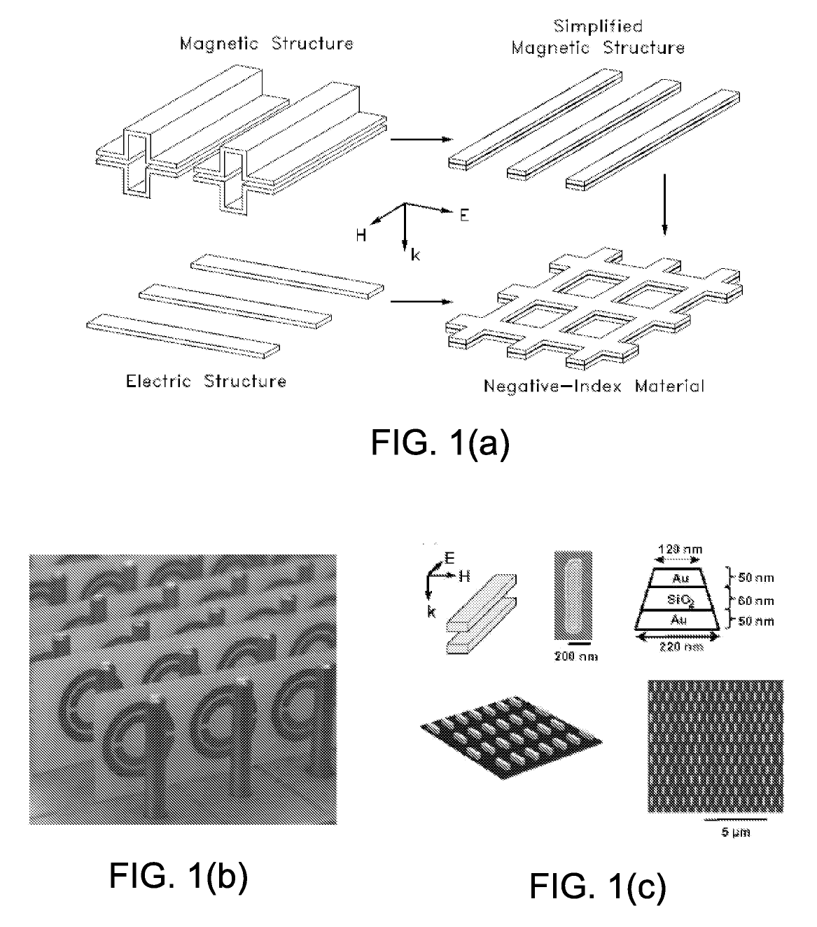

FIG. 1 illustrates a variety of negative refractive index metamaterial structures that can be implemented in exemplary optical elements of the optical interconnect devices and structures according to some embodiments of the present invention. FIG. 1(a) schematically illustrates a process for combining a magnetic structure with an electronic structure in order to obtain a sandwich-type grid-like metamaterial having a negative index of refraction. The structure in the upper left-hand corner of FIG. 1(a) is a metal-dielectric-metal so-called “staple” structure, which exhibits a negative permeability. This structure can be simplified to a planar structure, shown in the upper right-hand corner of FIG. 1(a), having a pair of finite-width metal stripes parallel to the direction of the magnetic field component of the source light. The pair of metal stripes are separated by a dielectric layer. The simplified magnetic structure favors higher frequencies than does the staple structure. The electric structure, shown in the lower left-hand corner of FIG. 1(a) can simply be an array of thin metallic wires along the direction of the electric field component of the source light. This arrangement of the metallic wires gives the electric component a negative permittivity. Combining the magnetic structure with the electronic structure to produce the sandwich-type grid architecture shown in the lower right-hand corner of FIG. 1(a) results metamaterial having a negative index of refraction. To fabricate this structure, any metal with a negative permittivity can be used. Exemplary metals include gold and silver. The dielectric must be chosen so as to give the magnetic structure an inductance/capacitance property. Exemplary dielectric materials include oxides such as silica and calcite.

A more negative value of the refractive index can be obtained when the magnetic field ridge widths differ greatly from the electric field ridge widths. It has been determined that for equal ridge widths, for example of about 500 nanometers (nm), there is only a very narrow region of negative relative permeability around a wavelength of about 1.75 micrometers (μm). Where there is a large aspect ratio of the magnetic field ridge width to the electric field ridge width, the region where both the permeability and permittivity are negative is much larger. In the case where the former is about 500 nm and the latter is about 100 nm, the region ranges from a wavelength of about 1.8 μm to about 2.05 μm.

The negative refractive index metamaterial shown in FIG. 1(b) is also a composite structure. The electric component exhibits negative dielectric behavior and includes a metal wire-mesh structure. The metal wires can be infinitely long, parallel, thin wires arranged in a square lattice such that the side of the square is significantly greater than the radius of the individual wires. This component is excited by a long wavelength electromagnetic wave (where the wavelength is significantly greater than the length of a side of the square lattice formed by two adjacent wires) with the electric field applied parallel to the wires. The magnetic component exhibits a negative magnetic permeability and includes a plurality of split-ring resonator structures. This component is excited by a long wavelength electromagnetic wave with the magnetic field component applied perpendicular to the plane of the split-rings. If an isotropic negative magnetic material is needed, then a three-dimensional split-ring resonator can be used instead of those shown in FIG. 1(b).

Finally, the negative refractive index material shown in FIG. 1(c) includes an array of parallel metal nanorods arranged in a so-called hexagonally close packed arrangement. Each of the metal nanorods (in this case shown as gold nanorods), includes a composite structure of a dielectric (in this case silica) sandwiched between two metal layers. The overall sandwich structure of the nanorod can be trapezoidal, as shown in the upper right-hand corner of FIG. 1(c). Each nanorod is generally much longer than it is wide. The nanorods are placed substantially parallel to each other. If each nanorod, were considered a point, then the nanorods would be arranged in a hexagonally close packed arrangement. The spacing between nanorods is also much greater than the width of the nanorods. The particular structure shown in FIG. 1(c) exhibited a negative index of refraction in the near-infrared spectrum. More specifically, a negative index of refraction at about 1.5 μm was measured.

It should be noted that the structures shown in FIG. 1 are for illustrative purposes, and are in no way intended to be limiting. One skilled in the art to which this disclosure pertains would readily understand that other negative refractive index metamaterial architectures or structures could be readily substituted for those shown in FIG. 1 in order to produce an optical interconnect device or structure for a particular application.

The metamaterials can be fabricated discretely and subsequently installed or applied as desired, or they can be fabricated directly on a microelectronic chip. The metamaterials can be fabricated discretely and subsequently installed or applied as desired, or they can be fabricated directly on a microelectronic chip. Many techniques can be used in order to fabricate the metamaterials or metamaterial-based optical elements. For example, electron-beam lithography, deep-ultraviolet lithography, multi-beam interference lithography, electron-beam evaporation, chemical vapor deposition, physical vapor deposition, or the like could be used.

In an exemplary embodiment, multi-beam interference lithography, in conjunction with a photo-mask, can be used to produce the metamaterials or metamaterial-based optical elements interferometrically, in accordance with the methods discussed in commonly-assigned U.S. patent application Ser. No. 11/970,502, which is hereby incorporated by reference in its entirety as if fully set forth herein. For example, one method in U.S. patent application Ser. No. 11/970,502 teaches generating a light beam, directing the light beam into a photo-mask having a set of diffractive elements and/or refractive elements to produce three or four non-coplanar beams of light, and focusing the three or four non-coplanar beams of light in a photosensitive recording material to produce a metamaterial interferometrically in the photosensitive recording material. The light source in such a method can be a deep-ultraviolet light source. The periods of the refractive elements or diffractive elements could be about 1 nanometer to about 100 nanometers in order to produce a metamaterial having low nanometer-scale features. The recording material can be a metal-dielectric-metal material multilayered structure, such that the dielectric layer is a dielectric oxide, glass, photosensitive composition, or the like, and the metal could be gold, silver, or other metal with a negative permittivity.

Once produced, regardless of the technique used, the metamaterial or metamaterial-based optical element can be further treated to have the desired physical attribute, such as shape, surface roughness, or the like. Depending on the sensitivity of the structure, the metamaterial can be encapsulated so as to provide it with improved chemical or physical resistance. Finally, the metamaterial or metamaterial-based optical element, can (if not already) be affixed to a microelectronic chip, for example, with an adhesive composition. These additional processing steps are known to those skilled in the art to which this disclosure pertains.

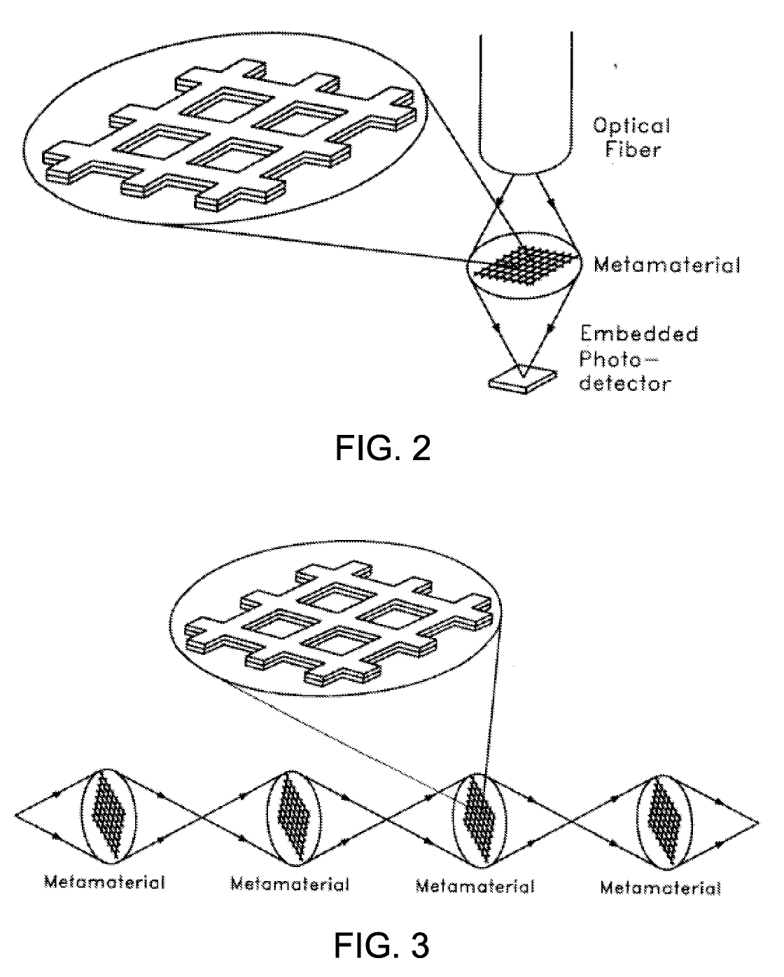

The negative refractive index metamaterial-based optical elements can be implement so as to provide different interconnection functions. For example, the optical elements can be used in structures such as fiber-to-chip couplers, waveguides, inter-chip couplers, intra-chip couplers, and the like. Reference will now be made to FIGS. 2-9, which illustrate some of these interconnect structures. In these figures, the various negative refractive index metamaterial-based optical elements are depicted as the sandwich-type checkerboard structures shown in FIG. 1(a) for convenience only. This is in no way intended to limit the scope of the optical elements so as to include only this architecture or type of metamaterial. Rather, one skilled in the art to which this disclosure pertains would readily understand that other negative refractive index metamaterials can be used to form the optical elements as desired for the particular interconnection function, light wavelength, application, and the like.

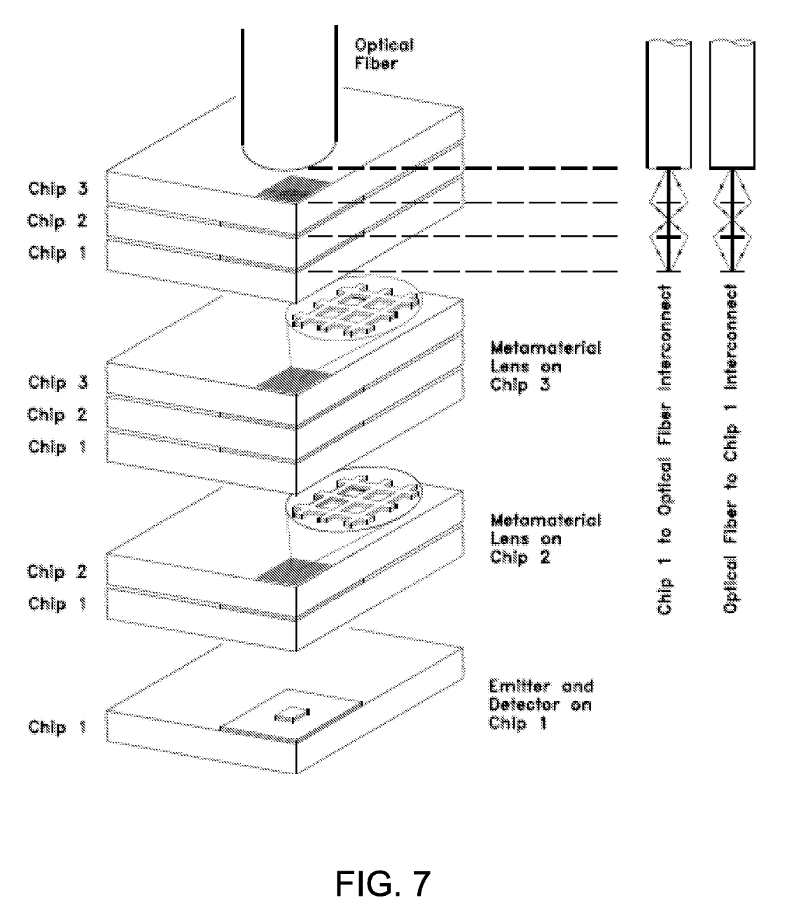

FIG. 2 provides a schematic illustration of a fiber-to-chip coupler. This optical interconnect generally includes a negative refractive index metamaterial-based optical element, an optical detector, and an optical fiber for transmitting the optical signal from a source to the optical detector. The negative refractive index metamaterial-based optical element can be incorporated into a semiconductor microelectronics chip to focus light from an external optical fiber onto a photo-detector (optical detector) that is embedded in the semiconductor chip or disposed on the semiconductor chip. An ideal negative refractive index metamaterial-based optical element would transfer the optical output modal pattern from the optical fiber to the photo-detector without degradation. This property of the negative refractive index metamaterial-based optical element facilitates transferring any modal pattern that exists at the output of the fiber to the photo-detector. FIG. 7 provides a more specific example of the optical interconnect shown in FIG. 2.

Alternatively, a series of negative refractive index metamaterial-based optical elements can be used in tandem to form a waveguide structure. Such an optical interconnect is illustrated in FIG. 3. This configuration is directly reminiscent of the first “light pipe” waveguides that were indeed composed of a series of lenses in a flexible mechanical tube. In the case of the negative refractive index metamaterial-based optical element waveguide, the light is passed without degradation from element to element. In addition to traveling in a straight line, the series of negative refractive index metamaterial-based optical elements can bend around corners. The waveguides can be used to transmit data signals from one location to another.

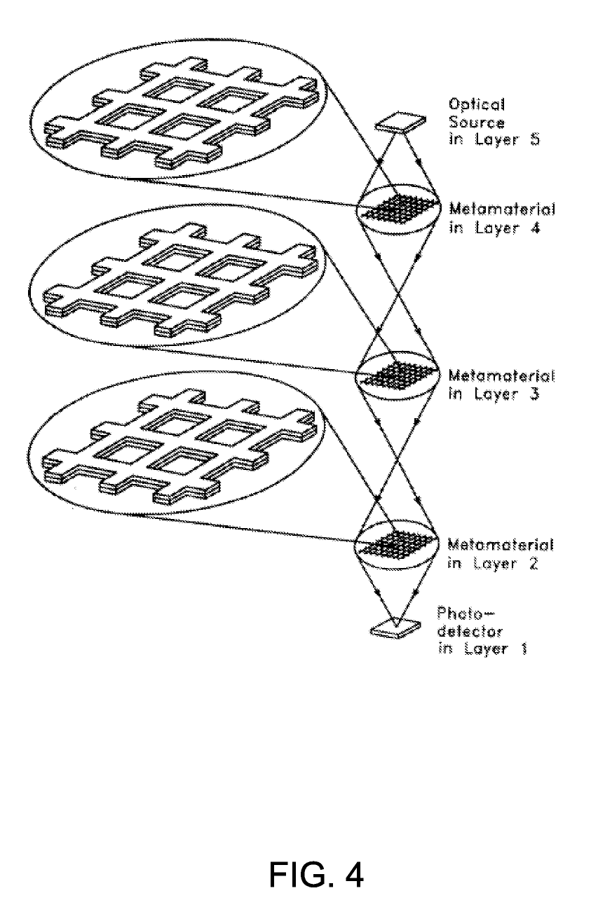

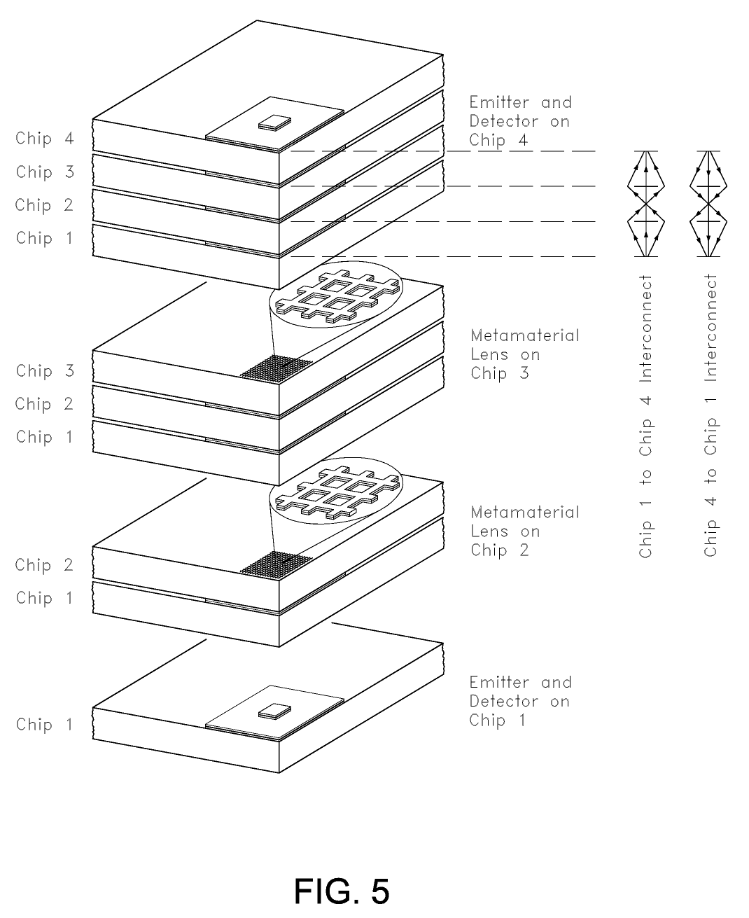

FIG. 4 schematically illustrates a generic optical interconnect for coupling or connecting multiple components. The components can be different devices and alternatively can be different components within a single integrated chip packaged device. The integrated chip packaged device can include a single chip or a plurality of stacked chips for greater component/chip density. For example, the optical interconnect shown in FIG. 4 can be used as an interconnect input/output that provide signals and power to a chip. Components can include integrated-circuits, semiconductor wafers, substrates, or any other items to be connected or coupled. Generally, the interconnects couple the end components by having ends attached, bonded, or coupled to a surface of the component. This particular optical interconnect includes an optical source, an optical detector, in the form of a photo-detector, and a plurality of negative refractive index metamaterial-based optical elements. During operation of this interconnect, an optical signal is emitted or produced by the optical source and transmitted through the plurality of negative refractive index metamaterial-based optical elements to the optical detector in the last or final component in the system. FIGS. 5-6 and 8-9 provide more specific examples of the optical interconnect system of FIG. 4.

Increasing demands on microelectronics has produced a strong emphasis on three-dimensional stacking of microelectronics chips. Such three-dimensional integration represents a major direction for future microelectronics. The metamaterial lenses can be efficiently used in three-dimensional microelectronics, for example, to interconnect the stacked chips. In these systems, an optical signal in one layer can be connected to an adjacent or to a distant layer. A vertical inter-chip integrated optical interconnect system is shown in FIG. 5.

The optical interconnect system shown in FIG. 5 is bi-directional, in contrast to the unidirectional optical interconnect system shown in FIG. 4. That is, the optical signal can be transmitted in both directions across the optical elements, rather than in only one direction. Accordingly, the two terminal chips or components of the optical interconnect system include both an optical source and an optical detector. An exemplary optical source is a laser, such as a near infrared laser to which the chips (and, naturally, the optical elements) are transparent. An exemplary optical detector is a photodiode. The chips that are disposed between the terminal chips comprise the metamaterials-based negatively refracting optical elements. For clarity, the optical path of the system is shown on the right-hand side of FIG. 5. The optical paths illustrate how an optical signal can be transmitted from Chip 1 and detected at Chip 4 and vice-versa.

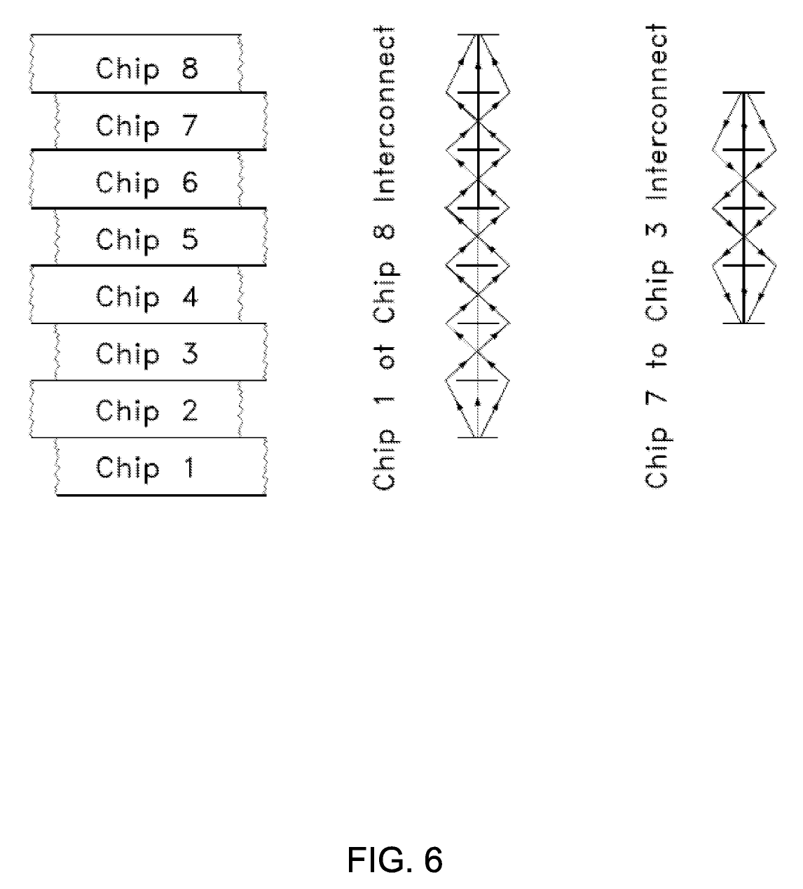

FIG. 6 provides a cross-sectional schematic view of a three-dimensional stack of chips having two different vertical inter-chip integrated optical interconnects and the respective optical paths for each optical interconnect. The first optical interconnect system is a unidirectional system configured to couple Chip 1 and Chip 8, whereas the second optical interconnect system is a unidirectional system configured to couple Chip 7 and Chip 3. With unidirectional systems, the optical elements on the penultimate chips (the ultimate or terminal chips in the interconnect system have a source and/or detector) have different focal lengths than those optical elements located in intermediate positions. For example, with respect to the first optical interconnect system shown in FIG. 6, the focal length of the optical element of Chip 2 is different than those of Chips 3-6, and is also different than that for Chip 7.

Instead of having a vertical inter-chip integrated optical interconnect system, one end of the system can be an optical fiber or a waveguide. Such a system is shown in FIG. 7. The optical interconnect system shown in FIG. 7 is bi-directional, in contrast to the unidirectional optical interconnect system shown in FIG. 2. As a result, Chip 1 includes both an optical source and an optical detector, and the ultimate component on the other side of the optical fiber can have both an optical source and an optical detector. The chips that are disposed between the Chip 1 and the optical fiber include metamaterials-based negatively refracting optical elements. Again, for clarity, the optical path of the system is shown on the right-hand side of FIG. 7. The optical paths illustrate how an optical signal can be transmitted from Chip 1 and through the optical fiber and from the optical fiber through to Chip 1.

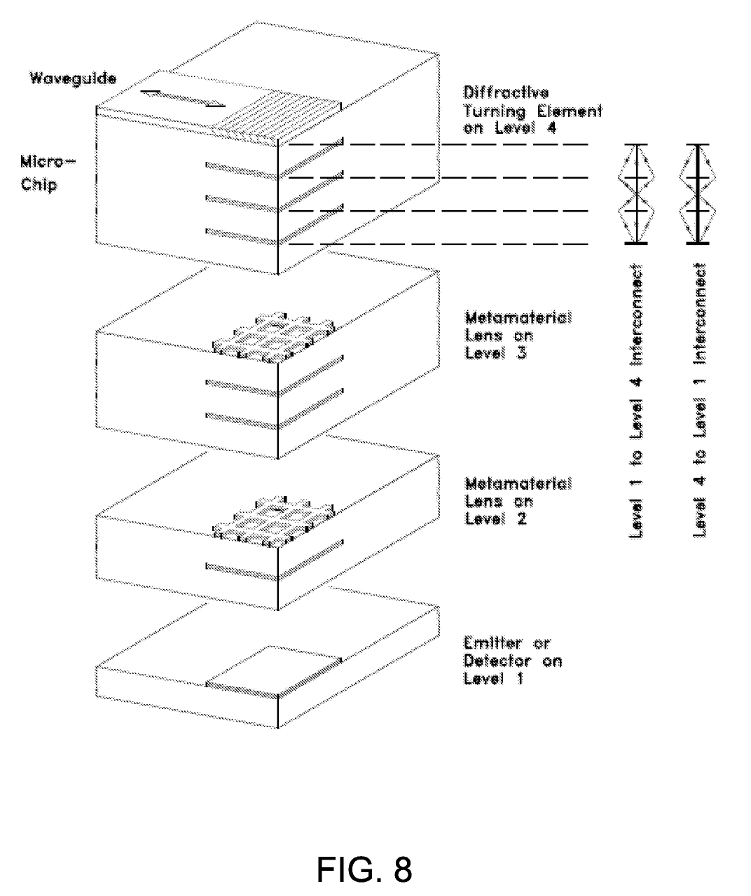

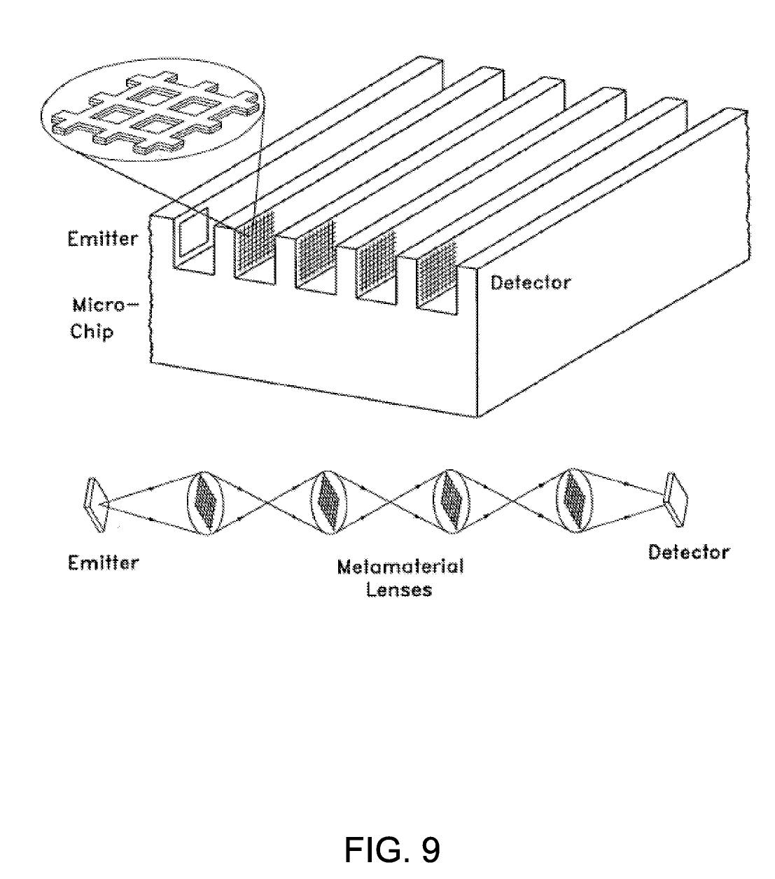

In contrast to the optical interconnect systems shown in FIGS. 5-7 where more than one stacked chip was involved, the optical interconnect systems shown in FIGS. 8-9 are intra-chip or on-chip systems. That is, the interconnect systems shown in FIGS. 8-9 couple components within or on a single chip.

A vertical intra-chip integrated optical interconnect system is shown in FIG. 8. This interconnect system includes an optical source and optical detector at a first location or component, a waveguide at a last location or component, and the metamaterials-based negatively refracting optical elements interposed between the waveguide and the optical source/optical detector. The waveguide can be used to reduce the complexity that might be needed if the two terminal components of the chip were directly coupled. That is, it may be difficult to build an interconnect system within a single chip that connects or couples the two terminal components. Instead a waveguide can be used to couple the remainder of the interconnect system to one of the two terminal components without having the interconnect system directly connected to that terminal component. The waveguide can be fabricated similar to the waveguide shown in FIG. 3, or can contain one or more of a refractive element, a diffractive element, or a reflective element in order to bend or manipulate the light path as desired.

FIG. 9 provides a horizontal intra-chip integrated optical interconnect system. This interconnect system includes an optical source, an optical detector, and a plurality of metamaterials-based negatively refracting optical elements interposed between the optical source and detector, all of which are disposed in channels or slits perpendicular to the top surface of the chip. This particular application is useful when bandwidth is limited or there is great complexity in fabricating the chip, and an optical interconnect is needed. Slits or channels having a depth of up to about 40 times the width of the channel can be fabricated. The various components of this optical interconnect system can be prepared within the high aspect ratio slits or channels so as to minimize their horizontal footprint on a top surface of the chip.

As illustrated, the various components in FIGS. 2-9 all have certain physical characteristics. Such characteristics include height, thickness, optical paths, number of optical elements, cross-section geometry, and the like. In some embodiments, it may be desirable to vary these characteristics. For example, and as described above, the type of negative refractive index metamaterials, the location of the optical element on each chip, the number of optical elements per application or per chip, whether the interconnect system is unidirectional or bidirectional, and the like can all be varied as desired. Advantages of using a different negative refractive index metamaterial include the ability to tailor the refractive index and wavelength sensitivity of the interconnect so as to minimize losses. Other varying physical characteristics are also achievable in accordance with other embodiments of the present invention.

The wavelength of light produced by the optical source is selected such that the components disposed between the optical source, various optical elements, and optical detector are transparent thereto. Silicon CMOS microelectronic chips are transparent to near-infrared light. Thus, in exemplary embodiments, the wavelength used for the optical interconnect system is in the near-infrared portion of the spectrum. A particularly exemplary wavelength is about 1.3 μm to about 2.0 μm, and more specifically about 1.5 μm.

It should be apparent that while the various optical interconnect systems shown in FIGS. 5-9 were used to connect non-adjacent chips or components within a chip, the optical interconnect systems could be configured to couple adjacent chips or components within a chip. This can be accomplished by placing the negative refractive index metamaterial-based optical element together in the same layer or location as the source, the detector, or both (for situations where the system is bidirectional).

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof. For example, temperature and pressure parameters may vary depending on the particular materials used.

Therefore, while embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. An optical interconnect, comprising:
an optical element comprising a metamaterial having a negative index of refraction, wherein the optical element is configured to receive an optical signal from a first component and transmit the optical signal to a second component.

2. The optical interconnect of claim 1, wherein the optical element has a substantially planar shape.

3. The optical interconnect of claim 1, wherein the metamaterial comprises a grid-shaped structure formed from a metal-dielectric-metal sandwich, a plurality of staggered nanorods having parallel longitudinal axes wherein each nanorod is formed from a metal-dielectric-metal sandwich, or an array comprising a plurality of parallel metal wires arranged in a square lattice and a plurality of split-ring resonators.

4. The optical interconnect of claim 1, wherein the optical element has the negative index of refraction at a wavelength of light of about 1.3 micrometers to about 2.0 micrometers.

5. An optical interconnect system, comprising:
a microelectronic chip; and
an optical element comprising a metamaterial having a negative index of refraction, wherein the optical element is configured to receive an optical signal from a component of the microelectronic chip and/or transmit the optical signal to the component of the microelectronic chip.

6. The optical interconnect system of claim 5, further comprising an optical fiber, wherein the optical fiber is in optical communication with the component of the microelectronic chip via the optical element.

7. The optical interconnect system of claim 6, wherein the optical communication is unidirectional.

8. The optical interconnect system of claim 6, wherein the optical communication is bidirectional.

9. The optical interconnect system of claim 6, wherein the microelectronic chip comprises an additional component, wherein the component of the microelectronic chip is in optical communication with the additional component of the microelectronic chip via the optical element.

10. The optical interconnect system of claim 9, wherein the optical communication is unidirectional.

11. The optical interconnect system of claim 9, wherein the optical communication is bidirectional.

12. The optical interconnect system of claim 5, further comprising:
an additional microelectronic chip; and
an additional component on the additional microelectronics chip, wherein the component of the microelectronic chip is in optical communication with the additional component of the additional microelectronic chip via the optical element.

13. The optical interconnect system of claim 12, wherein the optical communication is unidirectional.

14. The optical interconnect system of claim 12, wherein the optical communication is bidirectional.

15. An optical interconnect system, comprising:
an optical source configured to provide an optical signal;
an optical detector configured to detect the optical signal; and
an optical element interposed between the optical source and the optical detector, wherein the optical element comprises a metamaterial having a negative index of refraction, wherein the optical element is configured to receive the optical signal from the optical source and/or transmit the optical signal to the optical detector, and wherein one or more of the optical source, optical detector or optical element are in physical communication with a microelectronic chip.

16. The optical interconnect system of claim 15, further comprising an optical fiber interposed between the optical source and the optical element and/or between the optical detector and the optical element.

17. The optical interconnect system of claim 15, wherein the optical source, optical detector, and optical element are in physical communication with the same microelectronic chip.

18. The optical interconnect system of claim 15, wherein the optical source, optical detector, and optical element are each in physical communication with different microelectronic chips.

19. The optical interconnect system of claim 15, further comprising an optical waveguide interposed between the optical source and the optical element and/or between the optical detector and the optical element.

20. The optical interconnect system of claim 16, further comprising one or more of a refractive element, a diffractive element, or a reflective element interposed between the optical source and the optical element and/or between the optical detector and the optical element.
